(19) United States
(12) Patent Application Publication
(10) Pub. No.: US 2006/0147591 A1
(43) Pub. Date: Jul. 6, 2006

(54) Method and installation for cleaning cereal

(76) Inventors: Walter Eugster, Niederuzwil (CH); Othmar Gerschwiler, Jonschwil (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/541,392

(22) PCT Filed: Jan. 27, 2003
(86) PCT No.: PCT/CH03/00062

§ 371 Date: Jul. 1, 2005

(30) Foreign Application Priority Data
Jan. 2, 2003 (DE) 103 00 295.2

(51) Int. Cl. A23L 1/216

(52) U.S. Cl. 426/481

(57) ABSTRACT

The invention relates to a method and installation for cleaning cereal grains, particularly wheat. Cleaned and moistened wheat is moistened once again on the surface thereof, and the outer hulls are removed in a hulling machine (20). Afterwards, the dehulled cereal grains can be ground and polished.

The invention relates to a method and a device for cleaning grain, in particular for reducing contaminants in shells or layers of cereal grains proximate to the surface, e.g., wheat.

Grain, e.g., wheat or rye, can be cleaned wet and/or dry to remove, loose shells or contaminants from the grain surface. In past decades, largely dry cleaning has become the most popular. For example, CH-A-640750 describes a method in which what is subjected to dry cleaning, including scouring and aspiration. The wheat is subsequently wetted and stored for several hours in conditioning cells. After conditioning, the wheat is shelled directly prior to the first grinding pass. Shelling can here also be preceded by conditioning. This takes place after wetting and conditioning as a function of the degree to which the grains have been shelled and/or mellowed.

Also known is to polish wheat grains until they have dissolved form the fruit wall, and the endosperm is exposed (EP-B-218012). In this case, the fruit walls are incrementally removed in several polishing steps, wherein moisture is supplied to the grains in at least one step. The moistened grains can additionally be heated to gelatinize the surface of the wheat grains. After heating, which can take place concurrently with moistening, the grains are dried and cooled. According to EP-B-529843, wetted and polished wheat is again cleaned. This is a wet cleaning process intended to remove still adhering bran particles, primarily from the furrow as well.

Just as known are grain-grinding machines with vertically arranged rotor according to EP-B-742048, in which the grains to be ground can additionally exposed to a stream of air and wetted with water.

In the so-called PeriTec method, the outer cell layers are to be ground off, including the aleuron layer. Wheat is cleaned and wetted similarly to conventional methods, but scouring machines need not be used. This is intended to detach the outer from the inner layers, which then are ground off until under the testa. The bran is abrasively removed in a vertical grinding machine in a first stage, and via friction polishing in a second stage. This is intended to drastically reduce the conditioning times after wetting prior to grinding. It is only to take approx. 30 minutes for the water used in mellowing to penetrate. Contaminant loads are simultaneously decreased.

In a method for treating dry and clean wheat grains according to EP-B-373274, the exposed bran shell is to be removed, wherein the grains are moistened before conditioning for grinding preparation in such a way that the outer shell layers are conditioned without swelling, and that the grains are subsequently (within 1 to 5 minutes) subjected to several friction processes for removing the outer shells and grinding processes for removing and separating the inner shell layers.

The object of the invention is to develop a method for cleaning grain making it possible to further simplify the cleaning of grain, in particular wheat.

The object is achieved with the features in claim 1. According to the invention, this is accomplished by superficially wetting cleaned, wetted and conditioned wheat and then directly shelling it.

The subclaims disclose advantageous embodiments. In particular, shelling can be followed by grinding and, if needed, polishing of the grain surfaces.

In order to largely avoid contamination of the grinding material during subsequent grinding, the mill largely does without horizontal, in particular mechanical, conveying elements.

The shelling method according to the invention can be used for soft wheat and durum alike, wherein a lower contaminant content is achieved in the grains to be ground. Contaminant-laden bran can be specifically processed and recovered. As an alternative to shelling, the grain surface can be intensively ground or scoured. This process influences flour quality, and alters grinding.

Another object is to provide a device for cleaning grain, in particular wheat. This object is achieved with the features of claim 7.

The invention will be descried in greater detail below in an exemplary embodiment based upon a drawing. The drawing shows:

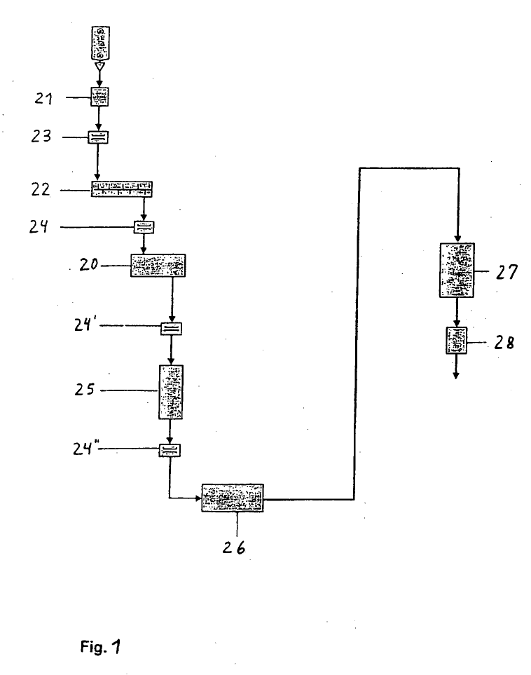

FIG. 1: A process diagram

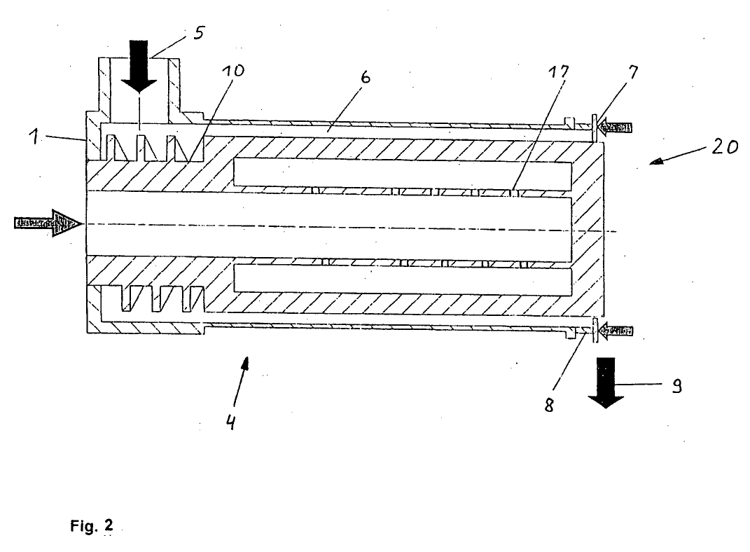

FIG. 2: A shelling machine

Cleaned as well as wetted and conditioned wheat exits from conditioning cells (not shown) into a metering unit 21, and from there by way of a magnet 23 into a wetting or conditioning aggregate (22), where the necessary moisture (shell conditioning) is set (approx. 2% water added in example). The wetting aggregate has a wetting screw, but two screws are also possible as an alternative. The wetted wheat is guided by a magnet 23, and enters shelling machine 20, where the wheat is shelled with a shelling degree of approx. 4%. The wheat is exposed to a stream of air during shelling.

The shelled wheat is guided by another magnet 24 into a vertical grinding machine 25, e.g., a stone grinding machine, and from there via a magnet 24″ into a polishing machine 26.

The wheat cleaned and prepared in this way is temporarily stored in a depot 27, and relayed via a metering unit 28 to grinding, starting with the first scrap.

The siftings from the shelling machine 20 and the light product accumulating from aspiration is isolated, separately ground, pressed into pellets, and, for example, earmarked for use as a fuel. The siftings resulting from grinding and polishing are also processed in this manner.

The stator 1 of the shelling machine 20 has a casing 2 that envelops a rotor 3 incorporated therein, is mounted on a frame rack, and is opened to the bottom via abutting discharge slats 4. These discharge slats carry away the siftings comprised of flour peels and shell parts.

The wheat grains pass from a product inlet 5 via a feed screw 10 into the processing zone 6. During shelling, the wheat grains are guided against an adjustable accumulating device 7 in order to generate a specific processing pressure in the processing zone 6. The shelled wheat grains exit the processing zone 6 through an adjustable outlet hole 8, and the shelling machine 20 via a discharge 9.

The processing zone 6 is formed on the stator side by two sifting elements, so that it completely envelops the rotor 3 in an axial direction. The rotor 3 consists of a chilled iron roll with a hollow screw. The roll has slits uniformly spaced apart on the circumference of the roll, which extend over the entire length of the processing zone 6.

The sifting baskets consist of individual sifting sheets.

The hollow screw has numerous holes for letting air out. The air passes further through the slits in the roll into the processing zone 6, and helps to separate shell parts, etc. from the wheat grains. The air is pressed into the hollow screw by means of a fan.

### REFERENCE LIST

1 Stator
2 Casing
3 Rotor
4 Outlet slats
5 Product inlet
6 Processing zone
7 Accumulating device
8 Outlet hole
9 Discharge
10 Feed screw
20 Shelling machine
21 Metering unit
22 Wetting aggregate
23 Magnet
24 Magnet
25 Grinding machine
26 Polishing machine
27 Depot
28 Metering unit

1. A method for cleaning grains, in particular wheat, in which the wheat is first cleaned, wetted and conditioned, and then superficially wetted, wherein surface processing involves shelling.

2. The method according to claim 1, characterized in that the surface of the cereal grains is ground after shelling.

3. The method according to claim 2, characterized in that the surface of the cereal grains is additionally polished after grinding.

4. The method according to one of claims 1 to 3, characterized in that the bran that forms while shelling and/or the light fraction obtained while sifting is ground and pressed into pellets.

5. The method according to claim 4, characterized in that the pellets are used as a fuel.

6. The method according to at least one of claims 1 to 3, characterized in that the shelled cereal grains are subsequently ground, avoiding horizontal conveying elements in the mill.

7. A device for cleaning grain, comprised of weighing and metering elements, characterized in that a wetting aggregate (22) followed by a shelling machine (20) is placed downstream from the weighing element and metering element in the direction of product flow.

8. The device according to claim 7, characterized in that the shelling machine (20) incorporates a rotatable rotor provided with processing tools, and a stator comprised of processing tools and sifting baskets, which envelop the rotor and form a processing zone (6), wherein the rotor (3) consists of a hollow shaft enveloped in the area of the processing zone (6) by an outer roll.
